(19) United States
(12) Patent Application Publication
(10) Pub. No.: US 2009/0071209 A1
(43) Pub. Date: Mar. 19, 2009

(54) Cam lock conversion assembly

(76) Inventor: Alan E. Lurie, Centerport, NY (US)

Correspondence Address: CARTER, DELUCA, FARRELL & SCHMIDT, LLP, 445 BROAD HOLLOW ROAD, SUITE 420, MELVILLE, NY, 11747, US

(21) Appl. No.: 11/900,684

(22) Filed: Sep. 13, 2007

(51) Int. Cl. E05B 15/10

(52) U.S. Cl. 70/391

(57) ABSTRACT

A conversion assembly is disclosed for converting a standard cam lock assembly to a variety of different lock configuration. A kit is also provided which includes a standard cam lock subassembly and different components of a variety of lock configurations which facilitate use of the standard cam lock subassembly with the different lock configuration.

### BACKGROUND

1. Technical Field

The present disclosure relates to a conversion assembly for a standard cam lock assembly. More specifically, the present disclosure relates to a conversion assembly for converting a standard cam lock assembly having a rotatable bolt into a variety of different lock configurations including those having a linearly movable bolt.

2. Background Of Related Art

Standard cam lock assemblies are well known and can be used in most drawer and door applications. One such known cam lock assembly 10 shown in FIGS. 1 and 2 includes a cam lock subassembly 12, a cam or bolt 14 and a securement member 16. Lock subassembly 12 includes a threaded body 18 having one or more flats 20. In one embodiment, body 18 includes a pair of diametrically disposed flats 20. A head portion 22 defining a shoulder 22a defines a central opening 24 which encircles a key slot 26. A drive member 28 which includes a flat or flats 28a and is threaded projects from the end of the lock subassembly 12 opposite key slot 26. Drive member 28 is operably connected to internal components of the lock subassembly, which are known in the art and are not described in detail herein, such that a key (not shown) can be positioned in key slot 26 and operated to effect rotation of drive member 28. A nut 30 is provided to secure cam or bolt 14 onto drive member 28. Securement member 16 includes internal threads 16a and is threadly received about threaded body 18 of lock subassembly 12. Cam lock assembly 10 can be secured to a door or drawer by inserting lock subassembly 12 through an opening in the door or drawer (not shown) and threading securement member 16 onto lock subassembly 12 to clamp the door or drawer between shoulder 22a of head portion 22 and securement member 16. Lock washers 34 and 36 which include bendable tabs 34a and 36a are provided to prevent removal of nut 30 and securement member 16 from drive member 28 and lock subassembly 12, respectively. An adapter 31 can be provided to non-rotatably secure drive member 28 to bolt 14.

Although lock assembly 10 having rotatable cam 14 provides effective securement of certain doors and drawers, the lock assembly is not suitable for display cabinet use, deadbolt use and a variety of other uses requiring a linearly movable bolt. As such, when a need exists for a deadbolt lock or display cabinet lock assembly, a new lock assembly must be provided.

Accordingly, it would be desirable to have a conversion kit for converting a standard cam lock assembly having a rotatable bolt into a variety of different lock configurations including those having a linearly movable bolt, e.g., dead bolt or display cabinet type locks.

### SUMMARY

A lock assembly kit is provided which includes a cam lock subassembly defining a key slot and having an outwardly threaded body including at least one flat and a drive member which is rotatable in response to insertion of a key into the slot and rotation of the key. A first bolt is provided which is adapted to non-rotatably engage the drive member such that rotation of the drive member effects rotation of the first bolt. A cam member is provided which is adapted to non-rotatably engage the drive member and has a cam extension. A second bolt has a cam slot configured to receive the cam extension of the cam member. The cam member and cam slot are configured to effect linear movement of the second bolt upon rotation of the drive member.

In one embodiment, the kit includes a casing defining a bore dimensioned to receive the cam lock subassembly. In another embodiment, the kit includes a securement member adapted to threadably engage the externally threaded body of the cam lock subassembly to secure the cam lock subassembly to a door or drawer. The cam lock subassembly can include a head portion defining a shoulder such that the securement member clamps a door or drawer between the shoulder and the securement member.

In another embodiment, a lock assembly includes a cam lock subassembly having a first end defining a key slot, a second end including a rotatable drive member, and a body having external threads and at least one flat formed thereon. A casing includes a housing portion defining a bore having at least one flat wall portion, wherein the bore is dimensioned to receive the cam lock subassembly. A cam member is adapted to be non-rotatably connected to the drive member and a linearly movable bolt is adapted to engage the cam extension of the cam member and the bolt is movable between a retracted position and an extended position, wherein rotation of a key within the key slot of the cam lock assembly effects rotation of the drive member and the cam member to effect linear movement of the linear movable bolt. In one embodiment, the casing includes a base portion at one end of the housing portion and the bolt is linearly movable within the base portion of the casing.

In one embodiment, a biasing member is positioned within the base portion of the casing and urges the bolt to the extended position. An adapter having a shoulder can be provided which is supported on the drive member of the cam lock subassembly. A set screw can also be provided which engages the shoulder of the adapter to retain the cam lock subassembly within the bore of the casing. In one embodiment, the at least on flat includes a pair of diametrically opposed flats.

In another embodiment, the lock assembly includes a cam lock subassembly having a first end defining a key slot, a second end including a rotatable drive member, and body having external threads and at least one flat formed thereon. A retractable bolt includes a bolt portion and a substantially cylindrical body portion which defines a bore having at least one flat sidewall. The bore is dimensioned to receive the cam lock subassembly. A casing includes a housing portion defining a substantially cylindrical bore dimensioned to slidably receive the retractable bolt and a base portion defining an opening configured to allow passage of the bolt portion of the retractable bolt. A biasing member is positioned within the substantially cylindrical bore, wherein the retractable bolt is movable within the substantially cylindrical bore from an extended position to a retracted position and the biasing member is positioned to urge the retractable bolt to the retracted position. A cam member including a cam extension is adapted to be non-rotatably connected to the drive member. A retaining member is positioned within the bore of the retractable bolt and is adapted to engage the cam extension of the cam member such that the rotation of a key within the key slot of the cam lock assembly effects rotation of the drive member and the cam member to effect linear movement of the retaining member. The retaining member is movable through a slot formed in the retractable bolt and a slot formed in the casing when the retractable bolt is in the extended position to retain the retractable bolt in the extended position.

In one embodiment, the at least one flat on the body of the cam lock subassembly includes a pair of diametrically opposed flats. In one embodiment, the bolt portion of the retractable bolt is substantially Z-shaped. In one embodiment, an adapter is provided which includes a shoulder. The adapter is supported on the drive member in a position to engage a set screw to secure the cam lock subassembly within the bore of the retractable bolt. In one embodiment, the adapter defines a threaded bore which is dimensioned to threadably engage the drive member.

In one embodiment, the lock assembly includes an alignment pin secured to the retractable bolt and a longitudinal slot formed in the casing. The alignment pin is positioned and movable along the longitudinal slot to maintain alignment between the bolt portion of the retractable bolt and the opening in the casing.

### BRIEF DESCRIPTION OF DRAWINGS

Embodiments of the presently disclosed cam lock conversion assembly are disclosed herein with reference to the drawings, wherein:

FIG. 1 is a side perspective view with parts separated of a Prior Art cam lock assembly;

FIG. 2 is an assembled side perspective view of the Prior Art cam lock assembly shown in FIG. 1;

FIG. 3 is a side perspective view of one embodiment of a converted dead bolt lock assembly with parts separated including the presently disclosed conversion assembly and the prior art cam lock subassembly;

FIG. 4 is an assembled side perspective view of the converted dead bolt lock assembly shown in FIG. 3;

FIG. 5 is a side perspective view of one embodiment of a converted spring-loaded dead bolt lock assembly with parts separated including the presently disclosed conversion assembly and the prior art cam lock subassembly with parts separated;

FIG. 6 is an assembled side perspective view of the converted spring-loaded dead bolt lock assembly shown in FIG. 5;

FIG. 7 is a side perspective view of one embodiment of a converted plunger lock assembly with parts separated including the presently disclosed conversion assembly and the prior art cam lock subassembly;

FIG. 8 is an assembled, side perspective view from the bolt end of the converted plunger lock assembly shown in FIG. 7;

FIG. 9 is an assembled, side perspective view from the key slot end of the converted plunger lock assembly shown in FIG. 7;

FIG. 10 is a side perspective view of one embodiment of a converted snap-bolt lock assembly with parts separated including the presently disclosed conversion assembly and the prior art cam lock subassembly;

FIG. 11 is an assembled, side perspective view of the converted snap-bolt lock assembly engaged with a strike plate; and

FIG. 12 is an assembled, side perspective view of the converted snap-bolt lock assembly with the snap-bolt rotated 90° from its position shown in FIG. 11.

### DETAILED DESCRIPTION OF EMBODIMENTS

Embodiments of the presently disclosed cam lock conversion assembly will now be described in detail with reference to the drawings wherein like reference numerals designate identical or corresponding elements in each of the several views.

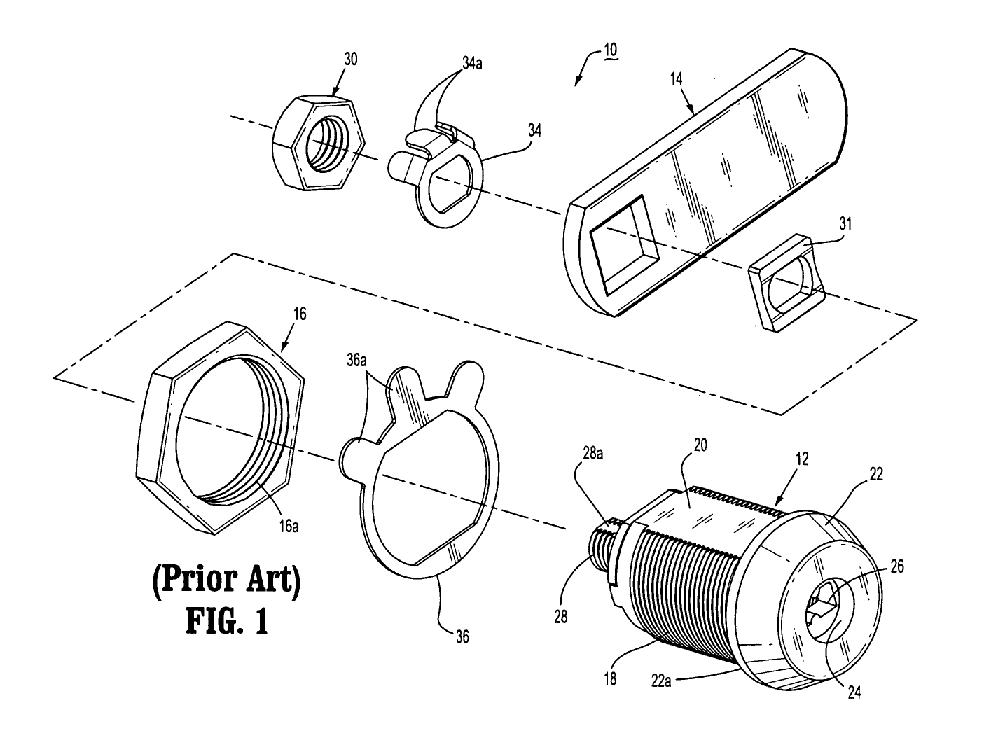

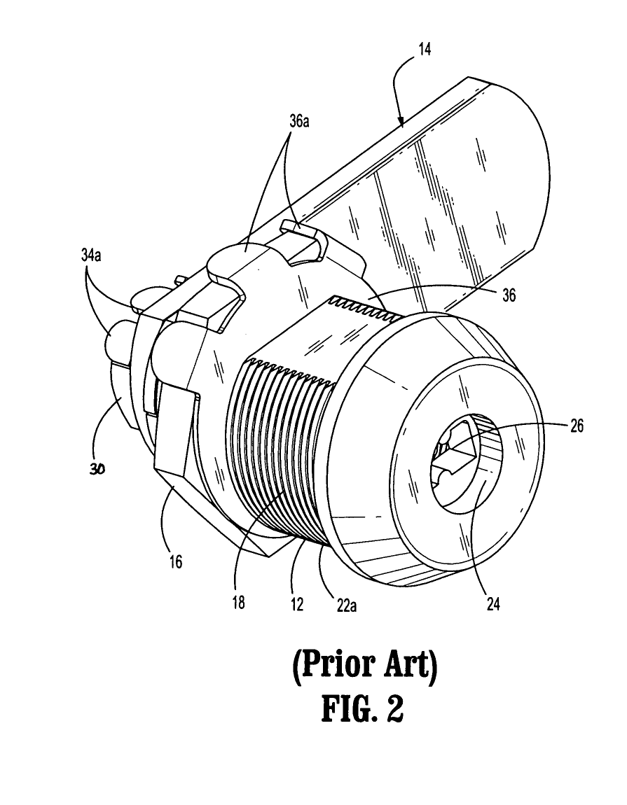

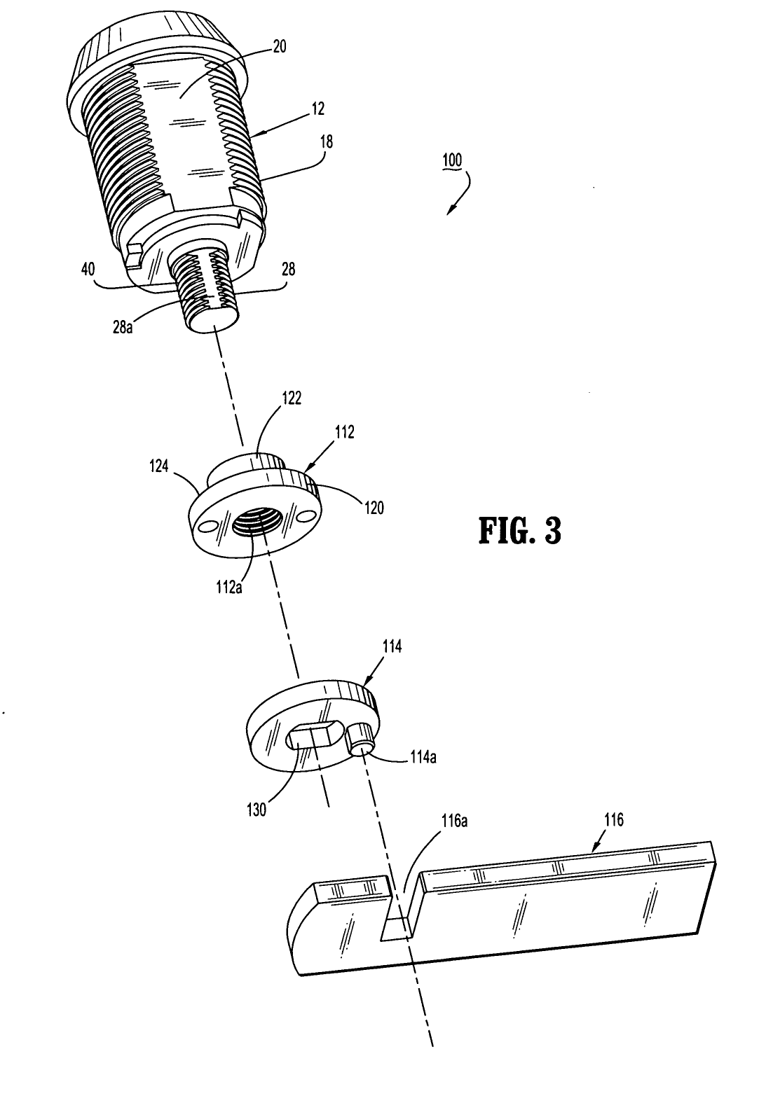

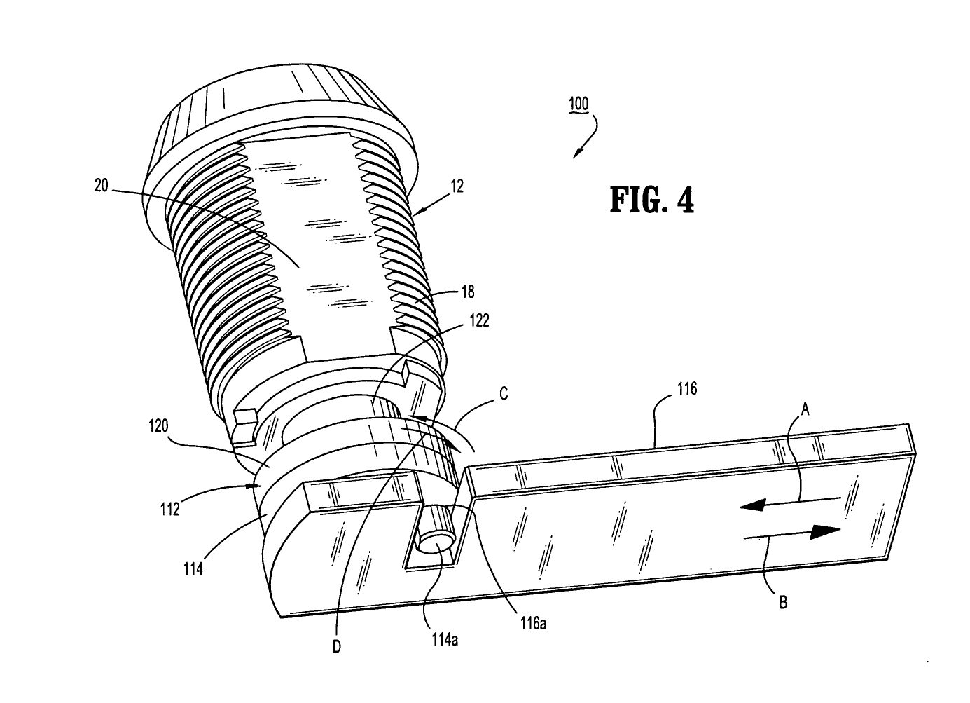

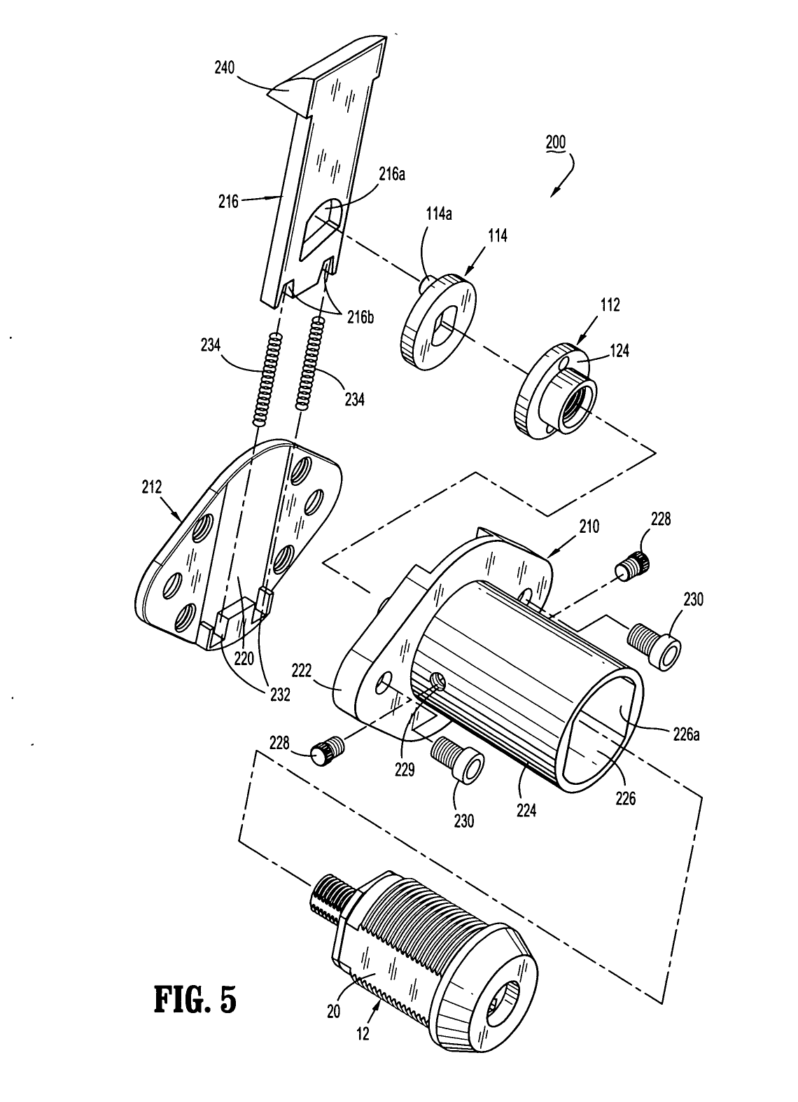

FIGS. 3 and 4 illustrate one embodiment of a cam lock assembly which has been converted to a dead bolt lock assembly 100. Dead bolt lock assembly 100 includes prior art lock subassembly 12, an adapter 112, a cam member 114 and a bolt 116. Although not shown, lock assembly 100 can also include a housing such as a housing similar to 200 described below (FIG. 5). Lock subassembly 12 is identical to the lock subassembly 12 of cam lock assembly 10 shown in FIGS. 1 and 2. Lock subassembly 12 includes a threaded body 18 having at least one flat 20. A drive member 28 which includes a flat or flats 28a extends from one end of lock subassembly 12. The opposite side of lock subassembly 12 includes a key slot 26 (FIG. 1). As discussed above drive member 28 includes a series of threads 40 and is rotatable by inserting an appropriately configured key (not shown) into key slot 26 and rotating the key. As also discussed above, the internal components of lock subassembly 12 are well known in the art and will not be discussed in further detail herein.

Adapter 112, as shown, has a stepped disc shape and defines a central threaded bore 112a dimensioned to receive threaded drive member 28. Adapter 112 includes a large diameter portion 120 and a smaller diameter portion 122 which together define a shoulder 124. Shoulder 124 defines an abutment surface which engages a set screw (not shown) to retain lock subassembly 12 within a lock casing (not shown).

Cam member 114 is disc shaped and defines a non-circular bore 130 configured to receive drive member 28. Bore 130 is substantially similar in configuration to drive member 28, i.e., bore 130 is defined by at least one flat wall 130a, such that rotation of drive member 28 of lock subassembly 12 effects rotation of cam member 114. Cam member 114 includes a cam extension 114a. It is envisioned that drive member 28 and bore 130 may assume a variety of configurations which allow drive member 28 to be non-rotatably coupled to cam member 114.

Bolt 116 is substantially rectangular in shape and includes a cam slot 116a. Cam slot 116a is positioned and dimensioned to slidably receive cam extension 114a of cam member 114. Although not shown, a casing is provided to limit bolt 116 to linear movement within the casing in the directions indicated by arrows “A” and “B” in FIG. 4. Similar casings are described below with reference to other lock assembly embodiments described herein.

In use, when an appropriate key (not shown) is inserted into key slot 26 (FIG. 1) of lock subassembly 12 and rotated, drive member 28 rotates, thus rotating cam member 114. When cam member 114 is rotated in either of the directions indicated by arrows “C” and “D” (FIG. 4), cam extension 114a engages a wall defining cam slot 116a of bolt 116 to move bolt 116 linearly in the direction identified by arrows A or B in FIG. 4. Thus, by substituting bolt 116 for bolt 14 (FIG. 1) and including adapter 112 and cam member 114, the rotary motion of bolt 14 of cam lock assembly 10 can be easily converted to the linear motion of bolt 116 to provide a dead-bolt type lock assembly.

It is noted that adapter 112 facilitates securement of lock assembly 100 within a casing (not shown) of the lock assembly. It is envisioned that a set screw can be provided which engages lock subassembly 12 directly, and adapter 112 can be eliminated from this assembly. This will become more evident in light of the discussion of the remaining embodiments.

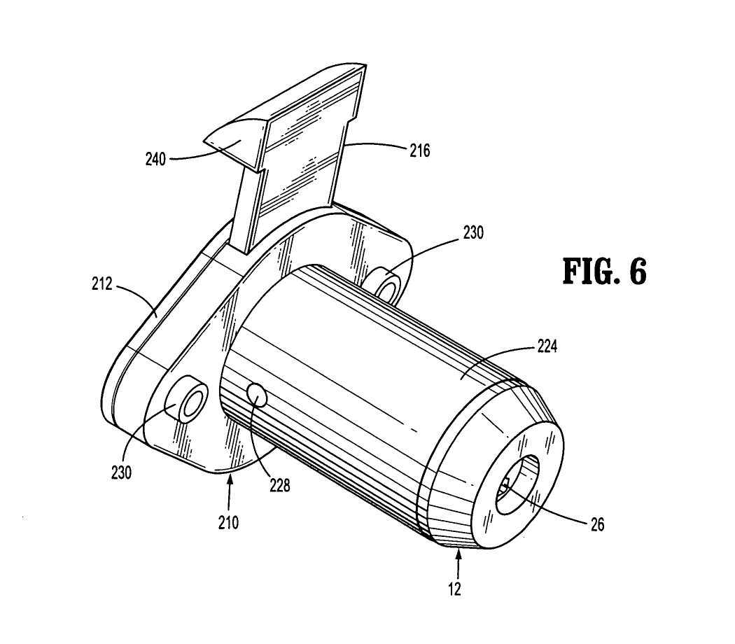

FIGS. 5 and 6 illustrate another embodiment of the presently disclosed conversion assembly in conjunction with a spring-loaded dead bolt lock assembly shown generally as 200. Spring-loaded dead bolt lock assembly 200 includes prior art lock subassembly 12, adapter 112, cam member 114, a lock assembly casing 210, a back plate 212 and a bolt 216. As discussed above with respect to lock assembly 100, adapter 112 and cam member 114 are supported on drive member 28 of lock subassembly 12 such that rotation of a key (not shown) within key slot 26 effects rotation of cam member 114. Bolt 216 includes a cam slot or opening 216a which is positioned to receive cam extension 114a. Bolt 216 is slidably positioned within a linear track 220 formed in back plate 212. When cam extension 114a is rotated by drive member 28 of lock subassembly 12, cam extension 114a engages the walls defining cam opening 216a to effect linear movement of bolt 216 along linear track 220 of back plate 212 between retracted and advanced positions.

Lock assembly casing 210 includes a base portion 222 and a substantially cylindrical housing portion 224. Housing portion 224 defines a bore 226 configured and dimensioned to receive lock subassembly 12. Bore 226 is defined by at least one flat sidewall portion 226a which abuts a flat 20 of lock subassembly 12 to prevent rotation of lock housing within bore 226. Alternatively, other techniques can be used to prevent rotation of housing portion 224 within bore 226, e.g., screws, etc. At least one set screw 228 extends through an opening 229 in cylindrical housing portion 224 and engages shoulder 124 of adapter 112 to axially secure lock subassembly 12 within bore 226. Back plate 212 is secured to base portion 222 of casing 210, such as by screws 230, to confine bolt 216 to linear movement. It is noted that screws 230 can extend through lock plate 212 first and then into base portion 222.

Back plate 212 defines a pair of cutouts 232 at one end of linear track 220. Each cutout is configured to receive one end of a biasing member or spring 234. The other end of spring 234 is positioned within cutouts 216b formed in one end of bolt 216 to urge bolt 216 to its advanced position extending from base portion 222.

In use, when a key is inserted into key slot 26 and rotated, drive member 28 is rotated to rotate cam member 114 and cam extension 114a. Cam extension 114a moves within and engages the walls defining cam opening or slot 216a to move bolt 216 linearly along linear track 220 against the bias of biasing members 234 from an advanced position to a retracted position. In the retracted position, a head portion 240 of bolt 216 is moved towards base portion 222 of casing 210.

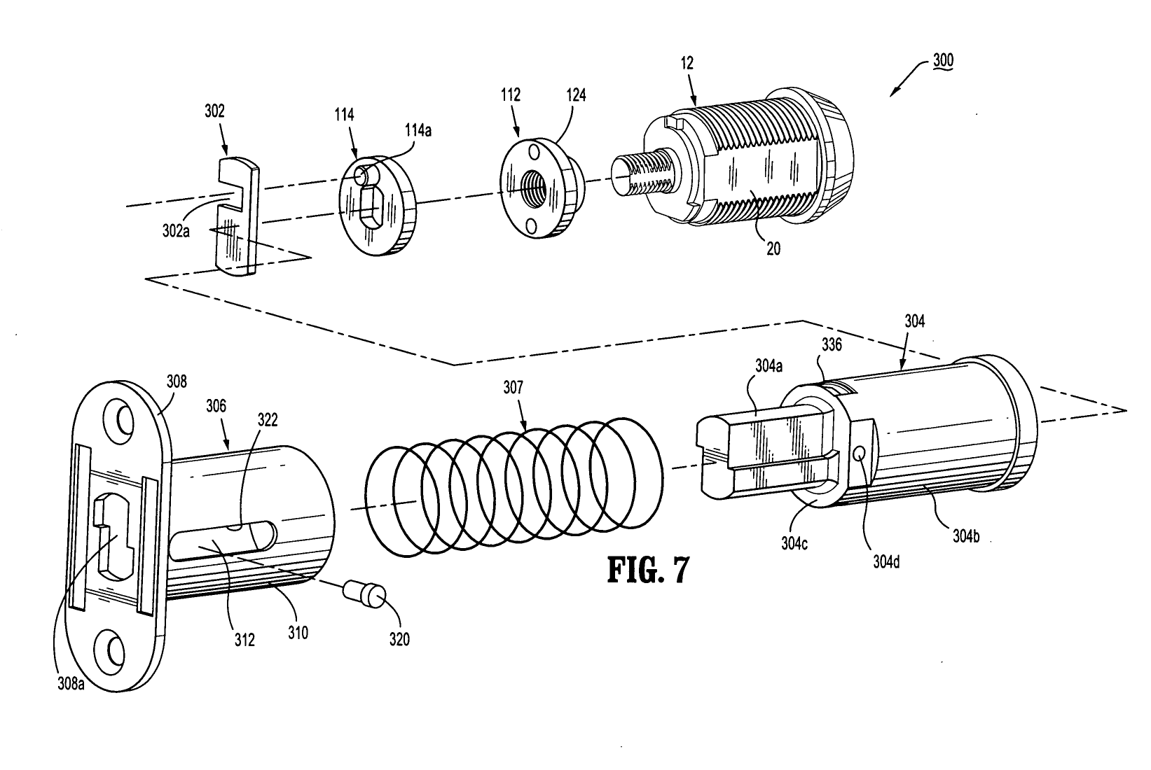

FIGS. 7-9 illustrate another embodiment of the presently disclosed conversion assembly in conjunction with a plunger lock assembly 300. Plunger lock assembly 300 includes a prior art lock subassembly 12, adapter 112, cam member 114, a retaining member 302, a retractable bolt 304, a casing 306 and a biasing member 307. As discussed above, adapter 112 and cam member 114 are secured to drive member 28 of lock subassembly 12 such that rotation of drive member 28 effects rotation of cam member 114.

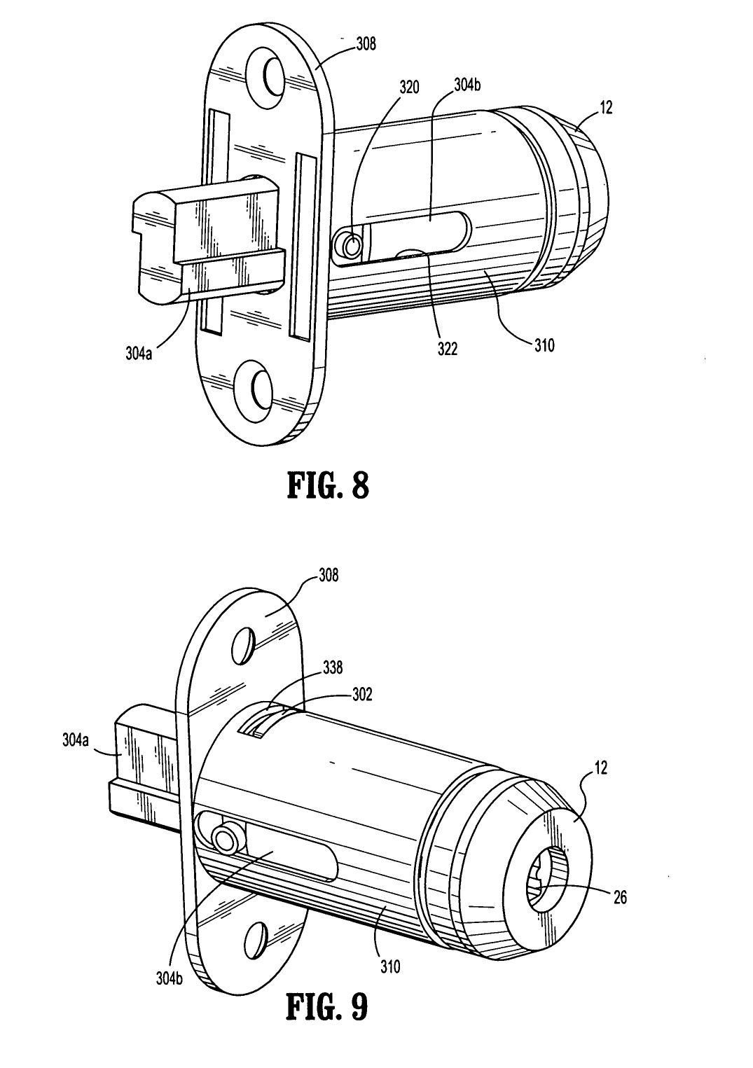

Casing 306 includes a base portion 308 and a cylindrical housing portion 310. Housing portion 310 defines a cylindrical bore 312 dimensioned to slidably receive retractable bolt 304. Base portion 308 defines an opening 308a which is dimensioned and configured to receive a bolt portion 304a of retractable bolt 304. Retractable bolt 304 includes bolt portion 304a and a substantially cylindrical body portion 304b which is dimensioned to be slidably received within housing portion 310 of casing 306. Although not shown, a set screw such as set screw 228 (FIG. 5) can be provided through bolt 304 to engage shoulder 124 of adapter 112 to axially secure lock subassembly 12 within bore 226. In one embodiment, bolt portion 304a has a Z-shape. Alternatively, other bolt configurations are envisioned, e.g., cylindrical, square, etc. Retractable bolt 304 is movable within casing 306 from a retracted position in which bolt portion 304a is positioned substantially within casing 306 to an advanced position in which bolt portion 304a extends from opening 308a of casing 306 (FIG. 8). Biasing member 307 is positioned within cylindrical bore 312 of casing 306 between an internal surface of base portion 308 of casing 306 and a distal surface 304c of body portion 304b of bolt 304. Biasing member 307 urges retractable bolt 304 towards the retracted position.

An alignment pin 320 is threadably received in a threaded bore 304d formed in bolt 304. Alignment pin 320 extends through a longitudinal slot 322 formed in casing 306 to maintain alignment of bolt portion 304a within opening 308a and to prevent removal of bolt 304 from housing portion 310 of casing 306.

Body portion 304b of bolt 304 defines a cylindrical bore (not shown) dimensioned and configured to receive lock subassembly 12. The cylindrical bore is defined by at least one flat surface which abuts flat 20 of lock subassembly 12 to prevent rotation of housing 12 within body portion 304b of bolt 304. Retaining member 302 defines a linearly movable bolt which is slidably supported in the base of the cylindrical bore defined by body portion 304b of bolt 304. Retaining member 302 includes a cam slot 302a positioned to receive cam extension 114a of cam member 114. A set screw (not shown) is provided to secure lock subassembly 12 within the cylindrical bore of bolt 304. The set screw extends through body portion 304b of bolt 304 and engages shoulder 124 of adapter 112. A slot or cutout 336 is provided in body portion 304b of bolt 304 and a slot or cutout 338 is provided in housing portion 310 of casing 306. Slots 336 and 338 are aligned with the linearly movable retaining member 302.

In use, when lock subassembly 12 and retaining member 302 are supported within body portion 304b of bolt 304 and bolt 304 is slidably positioned within cylindrical bore 312 of casing 306, biasing member 307 urges bolt 304 to its retracted position. Alignment pin 320 is positioned within slot 322 of casing 306 to prevent bolt 304 from being urged by biasing member 307 from body portion 304b of bolt 304. Bolt 304 can be manually pressed to move bolt 304 to its advanced position. When bolt 304 is in its advanced position, drive member 28 can be rotated, using a key (not shown) in key slot 26 (FIG. 9), to rotate cam member 114. As cam member 114 is rotated, cam extension 114a engages walls defining cam slot 302a to move retaining member 302 linearly through slot 336 in body portion 304b of bolt 304 and through slot 338 (FIG. 9) in housing portion 310 of casing 306. When retaining member 302 is positioned through slots 336 and 338, bolt 304 is retained in its advanced position with bolt portion 304a extending through opening 308a of casing 306.

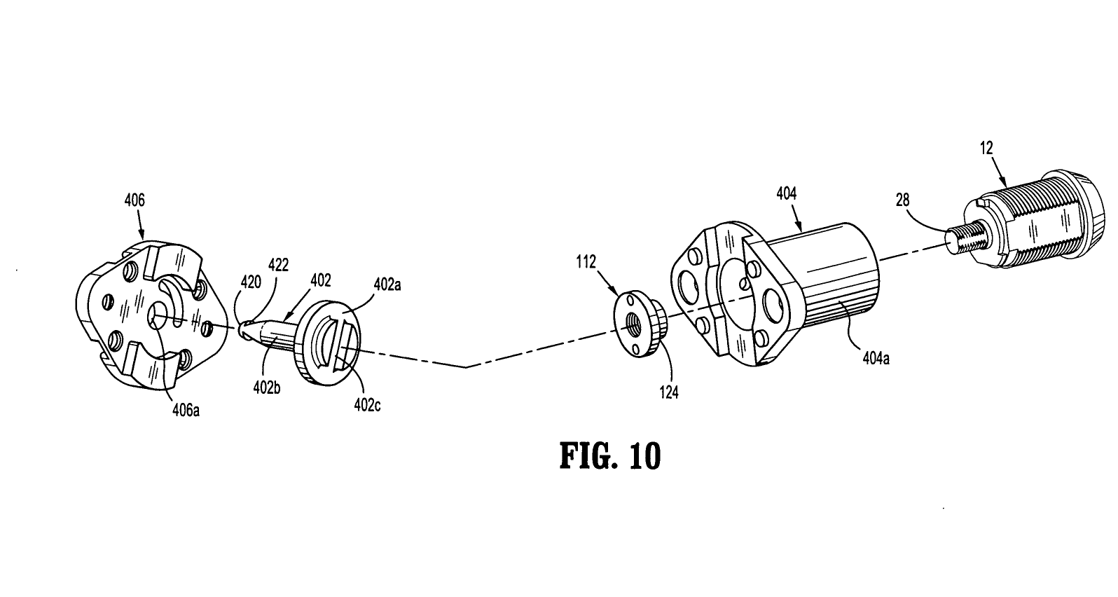

FIGS. 10-12 illustrate another embodiment of the presently disclosed conversion assembly in conjunction with a snap-bolt lock assembly shown generally as 400. Snap-bolt lock assembly 400 includes lock subassembly 12, adapter 112, bolt 402, casing 404 and back plate 406. Casing 404 includes a cylindrical housing portion 404a and a base portion 404b. Cylindrical portion 404a of casing 404 defines a cylindrical bore (not shown) defined by at least one flat wall for non-rotatably receiving lock subassembly 12. Bolt 402 includes a proximal engagement portion 402a defining a slot 402c dimensioned and configured to non-rotatably receive drive member 28 of subassembly 12. As discussed above, drive member 28 includes at least one flat 28a, e.g., two flats for being non-rotatably received within slot 402c. Thus, when drive member 28 is rotated as discussed above bolt 402 is also rotated. As discussed above, a set screw (not shown) is provided to secure lock subassembly 12 within casing 404. The set screw is positioned through casing 404 and engages shoulder 124 of adapter 112.

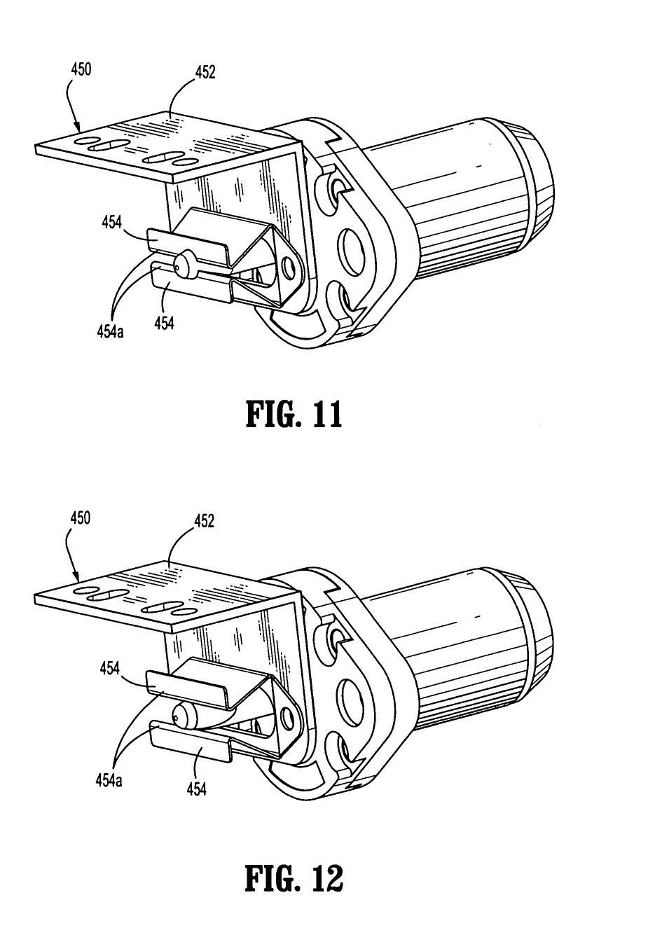

As illustrated, bolt 402 of snap-bolt lock assembly 400 includes a bolt portion 402b including an enlarged head portion 420 having a pair of diametrically opposed recesses 422. Bolt portion 402b is dimensioned to extend through an opening 406a in back plate 406. As illustrated in FIGS. 11 and 12, a strike 450 having a mounting plate 452 and a pair of spring arms 454 is provided. Bolt portion 402b is positionable between the spring arms 454 and is rotatable about 90° from an engaged position to a disengaged position. In its engaged position, spring arms 454 each include an angled portion 454a which is positioned within a recess 422 (FIG. 10) of bolt portion 402b to prevent removal of bolt portion 402b from between spring arms 454. When bolt portion 402b is rotated about 90°, angled portions 454a are moved from engagement within recesses 422 and spring arms 454 are cammed apart to allow disengagement of bolt portion 402b from spring arms 454.

As discussed above, a known cam lock assembly can be easily converted to a variety of different lock types by providing a new bolt, a casing and a cam member adapted to translate the motion of the drive member of the known cam lock assembly into a desired motion. Due to the ease of conversion between a variety of lock types, a kit is also disclosed herein which includes 1) a lock subassembly 12 defining a key slot 26 and including a rotatable drive member 28, 2) a first bolt adapted to engage and rotate with the drive member, 3) a cam member adapted to engage and rotate with the drive member, and 4) a second bolt including a cam slot configured to engage a cam extension of the cam member to convert rotary motion of the cam member into linear movement of the second bolt. The kit may further include any one or all of the various components described above required to construct a plunger lock, a dead bolt lock, a spring-biased dead bolt lock and/or a snap-bolt lock. For example, the kit may include one or more lock housings 12, one or more adapters 112, one or more cam members 114, one or more bolts 116, one or more retaining members 302, one or more retractable bolts 304, one or more biasing members 307, one or more casings 306, one or more bolts 216, one or more casings 210, one or more cam members 410, and/or one or more casings 404. With such a kit including only one key operated lock subassembly 12, any of the variety of lock types can be easily assembled to meet a specific need.

It will be understood that various modifications may be made to the embodiments disclosed herein. Therefore, the above description should not be construed as limiting, but merely as exemplifications of preferred embodiments. Those skilled in the art will envision other modifications within the scope and spirit of the claims appended hereto.

What is claimed is:

1. A lock assembly kit comprising:
a cam lock subassembly defining a key slot and having a drive member which is rotatable in response to insertion and rotation of a key in the key slot, the cam lock subassembly having an externally threaded body;
a first bolt adapted to non-rotatably engage the drive member such that rotation of the drive member effects rotation of the first bolt;
a cam member having a cam extension adapted to non-rotatably engage the drive member; and
a second bolt having a cam slot configured to receive the cam extension of the cam member, the cam member and cam slot being configured to effect linear movement of the second bolt upon rotation of the drive member.

2. A lock assembly kit according to claim 1, further including a casing defining a bore dimensioned to receive the cam lock subassembly.

3. A lock assembly kit according to claim 2, further including a securement member adapted to threadably engage the externally threaded body of the cam lock subassembly to secure the cam lock subassembly to a door or drawer.

4. A lock assembly kit according to claim 3, wherein the cam lock subassembly includes a head portion defining a shoulder, wherein the securement member clamps a door or drawer between the shoulder and the securement member.

5. A lock assembly comprising:
a cam lock subassembly having a first end defining a key slot, a second end including a rotatable drive member, and a body having external threads and at least one flat formed thereon;
a casing including a housing portion defining a bore having at least one flat wall portion, the bore being dimensioned to non-rotatably receive the cam lock subassembly;
a cam member adapted to be non-rotatably connected to the drive member; and
a linearly movable bolt adapted to engage the cam extension of the cam member, the bolt being movable between a retracted position and an extended position in relation to the casing;
wherein rotation of a key within the key slot of the cam lock assembly effects rotation of the drive member and the cam member to effect linear movement of the linear movable bolt.

6. A lock assembly according to claim 5, wherein the casing includes a base portion at one end of the housing portion, the bolt being linearly movable within the base portion of the casing.

7. A lock assembly according to claim 6, further including a biasing member positioned within the base portion of the casing, the biasing member urging the bolt to the extended position.

8. A lock assembly according to claim 7, further including an adapter having a shoulder, the adapter being supported on the drive member of the cam lock subassembly, and a set screw extending through the casing, the set screw engaging the shoulder of the adapter to retain the cam lock subassembly within the bore of the casing.

9. A lock assembly according to claim 5, wherein the at least one flat includes a pair of diametrically opposed flats.

10. A lock assembly comprising:
a cam lock subassembly having a first end defining a key slot, a second end including a rotatable drive member, and body having external threads and at least one flat formed thereon;
a retractable bolt including a bolt portion and a substantially cylindrical body portion defining a bore which is defined by at least one flat sidewall, the bore being dimensioned to receive the cam lock subassembly;
a casing including a housing portion defining a substantially cylindrical bore dimensioned to slidably receive the retractable bolt and a base portion defining an opening configured to allow passage of the bolt portion of the retractable bolt;
a biasing member positioned within the substantially cylindrical bore, wherein the retractable bolt is movable within the substantially cylindrical bore from an extended position to a retracted position and the biasing member is positioned to urge the retractable bolt to the retracted position;
a cam member adapted to be non-rotatably connected to the drive member, the cam member including a cam extension; and
a retaining member positioned within the bore of the retractable bolt, the retaining member being adapted to engage the cam extension of the cam member;
wherein the rotation of a key within the key slot of the cam lock assembly effects rotation of the drive member and the cam member to effect linear movement of the retaining member, the retaining member being movable through a slot formed in the retractable bolt and a slot formed in the casing when the retractable bolt is in the extended position to retain the retractable bolt in the extended position.

11. A lock assembly according to claim 10, wherein the at least one flat on the body of the cam lock subassembly includes a pair of diametrically opposed flats.

12. A lock assembly according to claim 1, wherein the bolt portion of the retractable bolt is substantially Z-shaped.

13. A lock assembly according to claim 10, further including an adapter including a shoulder, the adapter being supported on the drive member in a position to engage a set screw to secure the cam lock subassembly within the bore of the retractable bolt.

14. A lock assembly according to claim 13, wherein the adapter defines a threaded bore which is dimensioned to threadably engage the drive member.

15. A lock assembly according to claim 10, further including an alignment pin secured to the retractable bolt and a longitudinal slot formed in the casing, the alignment pin being positioned and movable along the longitudinal slot to maintain alignment between the bolt portion of the retractable bolt and the opening in the casing.
